(19) United States
(12) Patent Application Publication
(10) Pub. No.: US 2025/0085999 A1
(43) Pub. Date: Mar. 13, 2025

(54) INTER-CORE COMMUNICATION METHOD AND APPARATUS, COMPUTER EQUIPMENT AND COMPUTER-READABLE STORAGE MEDIUM

(71) Applicant: Samsung Electronics Co., Ltd., Suwon-si (KR)

(72) Inventors: Gang LI, Xi'an (CN); Lei WANG, Xi'an (CN); Chungwoo PARK, Xi'an (CN); Minhyung KIM, Xi'an (CN); Mindong ZHAO, Xi'an (CN)

(73) Assignee: Samsung Electronics Co., Ltd., Suwon-si (KR)

(21) Appl. No.: 18/778,012

(22) Filed: Jul. 19, 2024

(30) Foreign Application Priority Data
Sep. 8, 2023 (CN) 202311156140.3

(51) Int. Cl. G06F 9/455

(52) U.S. Cl. CPC G06F 9/45558; G06F 2009/45579

(57) ABSTRACT

The present disclosure provides an inter-core communication method and apparatus, a computer equipment, and a computer-readable storage medium. The inter-core communication method comprising: transmitting, with respect to at least one interrupt pass-through core configured for an interrupt pass-through mode among a plurality of cores, a physical interrupt directly to a client without going through a Hypervisor in response to the physical interrupt occurring, the Hypervisor being a virtual machine manager, and performing communication between the plurality of cores using a Fast Interrupt Request (FIQ).

### CROSS-REFERENCE TO RELATED APPLICATIONS

This application claims priority under 35 U.S.C. § 119 to Chinese Patent Application No. 202311156140.3, filed on Sep. 8, 2023, in the State Intellectual Property Office of the P.R.C., the disclosure of which is incorporated herein in its entirety by reference.

### TECHNICAL FIELD

The present disclosure relates to a technical field of virtualization and, more specifically, to an inter-core communication method and apparatus, a computer equipment, and a computer-readable storage medium.

### BACKGROUND

Recently, the application of a virtualization technology is becoming increasingly widespread. In existing virtualization technologies, a central processing unit (CPU) virtualization, a memory virtualization, an interrupt virtualization, and an apparatus virtualization that are based on a virtual machine manager (Hypervisor) are commonly used to virtualize a physical computer as a plurality of virtual computers. Although a Generic Interrupt Controller (GIC) of an ARM architecture can provide the interrupt virtualization with hardware supporting with respect to a virtual GIC (vGIC), the vGIC would introduce a large latency. To solve the latency problem, a GICv4 supporting a direct interrupt injection is proposed, but this direct interrupt injection method does not enable an interrupt-based inter-core communication of the Hypervisor.

No effective solution has been proposed for a problem of inability to achieve the inter-core communication of the Hypervisor due to the direct break injection in the related technologies.

### SUMMARY

The example embodiments of this disclosure are to provide an inter-core communication method and apparatus, a computer equipment, and a computer-readable storage medium.

According to a first aspect of an example embodiment of the present disclose, an inter-core communication method is provided, which including: transmitting, with respect to at least one interrupt pass-through core configured for an interrupt pass-through mode among a plurality of cores, in an interrupt pass-through mode, a physical interrupt directly to a client without going through a Hypervisor in response to the physical interrupt occurring, the Hypervisor being a virtual machine manager, and performing communication between the plurality of cores using a Fast Interrupt Request (FIQ).

According to a second aspect of an example embodiment of the present disclosure, an inter-core communication apparatus is provided, which including: an interrupt transfer unit configured to, with respect to at least one interrupt pass-through core among a plurality of cores and configured for an interrupt pass-through mode, transmit a physical interrupt directly to a client without going through a Hypervisor in response to the physical interrupt occurring, the Hypervisor being a virtual machine manager; and an inter-core communication unit configured to perform communication between the plurality of cores using a Fast Interrupt Request (FIQ).

According to an example embodiment of the present disclose, a computer equipment is provided, which including: at least one processor; and at least one memory storing computer executable instructions, wherein the computer executable instructions, when being executed by the at least one processor, cause the at least one processor to perform the inter-core communication method.

According to a forth aspect of an example embodiment of the present disclose, a computer-readable storage medium is provided, wherein, instructions in the computer-readable storage medium, when being executed by at least one processor, cause the at least one processor to perform the inter-core communication method as described above.

It should be understood that the above general description and the following detailed description are only illustrative and explanatory, and do not limit the present disclosure.

### BRIEF DESCRIPTION OF THE DRAWINGS

The accompanying drawings here are incorporated into the specification and form a part of the present specification, and show some example embodiments that comply with the present disclosure and used together with the specification to explain principles of the present disclosure, and do not constitute an improper limitation of the present disclosure.

FIG. 1 illustrates a diagram of an interrupt transfer method in the related art;

FIG. 2 illustrates a flowchart of an inter-core communication method according to some example embodiments of the present disclosure;

FIG. 3 illustrates a diagram of an interrupt pass-through mode according to some example embodiments of the present disclosure;

FIG. 4 illustrates a diagram of a processing of inter-core communication using a FIQ according to some example embodiments of the present disclosure;

FIG. 5 illustrates a flowchart of a method of driving a timer according to some example embodiments of the present disclosure;

FIG. 6 illustrates a flowchart of a method of driving a timer according to some example embodiments of the present disclosure; and

FIG. 7 illustrates a structural block diagram of an inter-core communication apparatus according to some example embodiments of the present disclosure.

FIG. 8 is a diagram of a system according to some example embodiments of the present disclosure.

### DETAILED DESCRIPTION OF EXAMPLE EMBODIMENTS

In order to enable those ordinary skilled in the art to better understand the technical solution of the present disclosure, technical solutions in some example embodiments of the present disclosure will be described clearly and completely in combination with the accompanying drawings.

The terms used herein are for a purpose of describing particular example embodiments and are not intended to limitation. As used herein, singular forms “a”, “an”, “the” and “this” are also intended to include the plural forms unless the context clearly indicates otherwise. In addition, terms “comprise”, “include” and/or variations thereof, when being used in this specification, indicates the presence of the stated feature, whole, step, operation, element, component, and/or groups thereof, but not excludes the presence or addition of one or more other features, wholes, steps, operations, elements, components, and/or groups thereof. The example embodiments described in the following disclosure do not represent all example embodiments that are consistent with the present disclosure. On the contrary, they are merely examples of apparatus and methods that are consistent with some aspects of the present disclosure, as detailed in the appended claims.

It should be noted here that “at least one of several items” appearing in the present disclosure all means that there are three kinds of juxtaposition situations: “any one of these items”, “combination of any number of these items”, and “all of these items”. For example, “including at least one of A and B” includes the following three juxtaposition situations: (1) including A; (2) including B; (3) including A and B. As another example, “performing at least one of operations 1 and 2”, that is, means the following three juxtaposition situations: (1) performing operation 1; (2) performing operation 2; (3) performing operations 1 and 2.

Specific example embodiments of the present disclosure will be described in detail below.

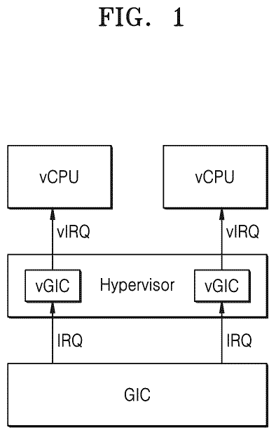

In related art, an inter-core communication of a Hypervisor mainly relies on an interrupt, and a current interrupt virtualization is mainly implemented based on a virtual GIC which is provided by the virtual machine manager (Hypervisor) (e.g., XEN, KVM, etc.) using a Generic Interrupt Controller (GIC) of an ARM architecture. An interrupt transfer method in the related art is firstly described below with reference to FIG. 1.

Referring to FIG. 1, a Hypervisor-based interrupt transfer method includes: detecting, by a GIC, a physical interrupt when the physical apparatus generates the physical interrupt; by the GIC, generating an operation request such as an Interrupt Request (IRQ) and transmitting the IRQ to the Hypervisor running on an Exception Level 2 (EL2); by the Hypervisor, converting the physical interrupt into a virtual interrupt and using a virtual GIC (vGIC) to transmit the virtual Interrupt Request (vIRQ) to a virtual CPU (vCPU) (or a virtual processing unit (vPE)) of a client running on an EL1.

As seen from the Hypervisor-based interrupt relay processing described above, the current interrupt virtualization technology often introduce a large interrupt latency, e.g., a vGIC hardware implementation of a ARM GIC introduces a large interrupt latency, the processing of converting the physical interrupt into the virtual interrupt and injecting the virtual interrupt into the vCPU of the client by the Hypervisor introduces a large interrupt latency, and scheduling algorithms for different vCPUs also have inconsistent latencies, etc. The latency introduced by the interrupt virtualization is often much larger than a latency in a bare metal environment, and for specific applications, many application scenarios (e.g., a cellular communication scenario, a flight control system, etc.) have high requirements (or alternatively, high desired features) on a magnitude and a stability of the interrupt latency, and the existing interrupt virtualization technologies often cannot meet the requirements (or alternatively, desires) for real-time performance in the different scenarios.

Therefore, in order to meet the requirements (or alternatively, desires) such as a higher requirement (or alternatively, high desires) for the interrupt latency and a need (or alternatively, desire) to improve an interrupt transfer efficiency, a new version of GIC is proposed in the related art. For example, a GICv4 can directly submit a Software Generated Interrupt (SGI) and a Locality-specific Peripheral Interrupt (LPI) to the client without going through the Hypervisor. But the GICv4 does not support a direct submission of a Shared Peripheral Interrupt (SPI), however, most of peripheral interrupts are SPIs. In this regard, the existing technology has a drawback of not being able to implement the transfer of all interrupts, etc.

Taking into account the above-mentioned problems and challenges of the related art, the present disclosure proposes a technical solution to abandon the use of the vGIC: configuring an ARM core in an interrupt pass-through mode and transferring all interrupts directly in the interrupt pass-through mode in which interrupts may be transmitted directly to the client on the EL1 without going through the Hypervisor on the EL2. By simplifying an interrupt transfer path, it can saving a time for interrupt transfer and greatly improve resource utilization, it is possible to obtain interrupt latency roughly equivalent to that of the bare metal environment, and achieve good extensibility by reducing the interrupt latency while transferring various types of interrupts. This will be described in detail in the following sections.

On the other hand, in addition to the problems or challenges of high latency and poor extensibility, a challenge still exists that directly injecting interrupts cannot achieve inter-core communication of the Hypervisor. In the related art, interrupts can be broadly classified into three types: a Software Generated Interrupt (SGI), a Private Peripheral Interrupt (PPI) and a Shared Peripheral Interrupt (SPI), wherein the SGI is used for communication between physical cores. When an interrupt does not go through the Hypervisor of an EL2, the inter-core communication relying on the SGI cannot be performed because the cores on the EL2 cannot receive any interrupt. At this point, a method is needed (or alternatively, desired) that enables the inter-core communication of the Hypervisor in the interrupt pass-through mode.

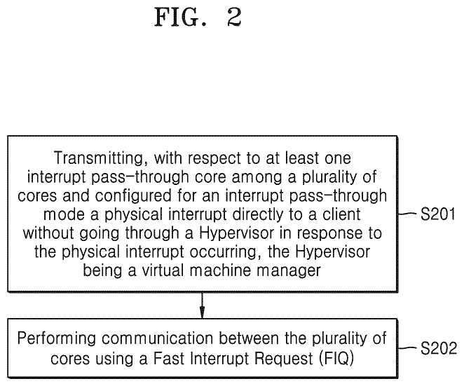

Accordingly, the present disclosure provides an inter-core communication method and apparatus, a computer equipment, and a computer-readable storage medium that can perform the inter-core communication in a case that the interrupt pass-through mode is used to reduce latency. The inter-core communication method and apparatus, computer equipment, and computer-readable storage medium according to some example embodiments of the present disclosure will be described below in conjunction with FIG. 2 to FIG. 7.

It should be understood that the above application scenarios are only examples, and some example embodiments according to the present disclosure are not limited to the above application scenarios.

FIG. 2 illustrates a flowchart of an inter-core communication method according to some example embodiments of the present disclosure.

Referring to FIG. 2, at operation S201, with respect to at least one interrupt pass-through core configured for an interrupt pass-through mode among a plurality of cores, a physical interrupt is transmitted directly to a client without going through a virtual machine manager (Hypervisor) when the physical interrupt occurs. At operation S202, communication between the plurality of cores is performed using a Fast Interrupt Request (FIQ). Here, the plurality of cores may be a plurality of ARM cores (or physical cores) on a system on chip (SoC).

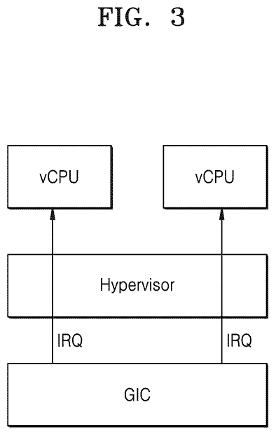

In the following, the interrupt pass-through mode in operation S200 will be described firstly in detail with reference to FIG. 3.

FIG. 3 illustrates a diagram of an interrupted pass-through mode according to some example embodiments of the present disclosure.

Referring to FIG. 3, when a core is in the interrupt pass-through mode and the GIC detects a physical interrupt, the GIC generates an interrupt request (IRQ), and transmits the physical interrupt through the IRQ directly to the client at an exception level 1 (EL1) without going through the Hypervisor at an exception level 2 (EL2). The Hypervisor does not receive any physical interrupt.

Alternatively, the at least one interrupt pass-through core in the interrupt pass-through mode is implemented, by configuring a register of the corresponding core by the Hypervisor. Specifically, a register HCR_EL2 may be used to route an exception (e.g., IRQ or FIQ) to the Hypervisor, here, the Hypervisor may configure the at least one core as the interrupt pass-through mode, by configuring a “IMO,bit[4]” of the at least one register HCR_EL2 corresponding to the at least one core to 0. Alternatively, the interrupt pass-through mode in which the interrupt does not go through the Hypervisor may be configured by any other suitable configuration manners.

In this case, the interrupt pass-through method is able to obtain an interrupt latency roughly equivalent to that of the bare metal environment due to abandoning interrupt conversion and interrupt relay using the vGIC of the Hypervisor. However, because the inter-core communication of the Hypervisor may rely on a Software Generated Interrupt (SGI) included in the IRQ and transmitted between physical cores for implementation, the Hypervisor that does not receive any interrupt cannot perform the inter-core communication, so the present application proposes to use a Fast Interrupt Request (FIQ) to perform the inter-core communication.

Alternatively, the client is running at the exception level 1 (EL1), and the Hypervisor and the plurality of cores are running at the exception level 2 (EL2). That is, the inter-core communication according to some example embodiments of the present disclosure is between a plurality of cores running at the EL2.

Although the Hypervisor cannot receive all interrupts included in the IRQ, it can receive the FIQ normally, and thus the present disclosure proposes to use the FIQ to transfer the SGI for the inter-core communication. Alternatively, the performing the communication between the plurality of cores using the Fast Interrupt Request (FIQ) includes: transferring the Software Generated Interrupt (SGI) between the plurality of cores through the FIQ.

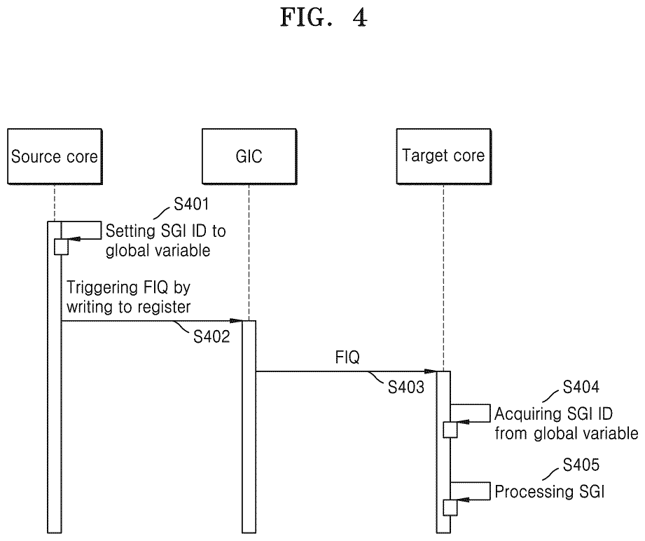

FIG. 4 illustrates a diagram of a processing of inter-core communication using a FIQ according to some example embodiments of the present disclosure.

Referring to FIG. 4, the inter-core communication between a source core which is a communication transmitting side and a target core which is a communication receiving side is illustrated.

Alternatively, the transferring the SGI between the plurality of cores through the FIQ includes: setting an interrupt number (SGI ID) indicating the SGI into a global variable by the source core which is a communication transmitting side among the plurality of cores; triggering, by writing to a SGI register by the source core, a Generic Interrupt Controller (GIC) to generate the FIQ to be transmitted to a target core which is a communication receiving side among the plurality of cores; transmitting the FIQ to the target core by the GIC, to instruct the target core to acquire the SGI ID from the global variable. This section is described below with reference to operations S401 to S403.

At operation S401, a source core sets a SGI ID into a global variable, wherein the SGI ID is used to indicate a SGI. Specifically, serial numbers of SGI IDs are 0 to 15, wherein each SGI ID may indicate its corresponding SGI.

Alternatively, the SGI ID that is set into the global variable may be one or more, and accordingly, the indicated SGI may be one or more.

Alternatively, the global variable is a variable that may be cited, set, accessed, or read by any core, for example, the global variable may be a per-cpu global variable.

At operation S402, the source core triggers a GIC to generate a FIQ by writing to a register. Specifically, the source core may firstly determine whether the target core is an interrupt pass-through core that cannot receive interrupts normally. If the target core is the interrupt pass-through core, the source core triggers the GIC to generate the FIQ by writing to a register, and if not, the source core triggers the GIC to generate an IRQ by writing to a register. Alternatively, the source core may trigger the GIC to generate the FIQ by writing to an ICC_SGIOR register.

At operation S403, the GIC transmits the generated FIQ to the target core after the FIQ is generated. Specifically, the FIQ may instruct the corresponding target core to obtain the SGI ID from the global variable.

Alternatively, the transferring the SGI between the plurality of cores through the FIQ includes: receiving the FIQ by the target core which is the communication receiving side among the plurality of cores, wherein the target core is one of the at least one interrupt pass-through core; acquiring the SGI ID indicating the SGI from the global variable by the target core in response to the FIQ being received by the target core, wherein the SGI ID is set into the global variable by the source core which is the communication transmitting side; performing a corresponding processing by the target core based on the SGI indicated by the SGI ID. This section is described below with reference to operation S404 and operation S405.

At operation S404, the target core acquires the SGI ID from the global variable in response to receiving the FIQ. Alternatively, the acquired SGI ID may be one or more, and accordingly, the indicated SGI may be one or more. Alternatively, the target core may acquire the SGI ID from the per-cpu global variable.

At operation S405, the target core determines the SGI based on the SGI ID and performs a processing corresponding to the SGI.

As such, when the target core is in the interrupt pass-through mode, by performing the inter-core communication by the FIQ, it may ensure that the interrupt pass-through core is capable to acquire the SGI ID from the global variable and determine the SGI, thereby performing the processing corresponding to the SGI, that is, the interrupt pass-through core is capable to perform the same function as that of a communication processing of receiving a SGI in an non-interrupt pass-through mode. According to the above inter-core communication method, it may ensure a normal operation of the inter-core communication in a case of achieving full interrupt pass-through, which improves the efficiency of interrupt transfer without affecting the execution of original functions, and may meet business needs with high real-time requirements.

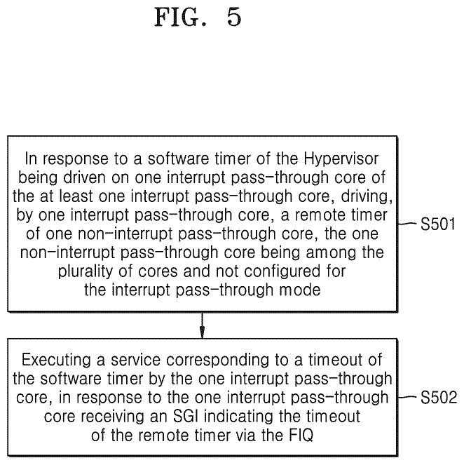

In addition, in the related art, when a user uses a software timer of the Hypervisor, a local timer using a hardware timer is firstly requested on the corresponding core, and then a processing corresponding to a timeout of the local timer is performed based on an interrupt of a timeout of the hardware timer. However, in the interrupt pass-through mode, the interrupt pass-through core using the local timer cannot receive an interrupt from the hardware timer, e.g., the local timer cannot use the hardware timer, which results in an inability to provide a service associated with the software timer of the Hypervisor. In this regard, according to the inter-core communication method of some example embodiments of the present disclosure, the interrupt pass-through core may indirectly receive the interrupt by communicating with a non-interrupt pass-through core, and therefore, in some example embodiments of the present disclosure, an inter-core communication method of implementing the software timer based on a remote timer is also proposed. This will be described in detail below with reference to FIG. 5.

FIG. 5 illustrates a flowchart of a method of driving a timer according to some example embodiments of the present disclosure.

Referring to FIG. 5, at operation S501, in response to a software timer of the Hypervisor being driven on one interrupt pass-through core of the at least one interrupt pass-through core, the one interrupt pass-through core drives a remote timer of one non-interrupt pass-through core that is not configured for the interrupt pass-through mode among the plurality of cores. That is, the interrupt pass-through core performs a function of a timer of this interrupt pass-through core by means of a timer of a non-interrupt pass-through core that may work properly.

Since the interrupt pass-through core is unable to receive the interrupt from the generic timer in the hardware architecture, the interrupt pass-through core performs the corresponding function of the timer by means of a remote timer of the non-interrupt pass-through core capable of receiving the interrupt from the generic timer. Alternatively, the driving the remote timer of the one non-interrupt pass-through core by the one interrupt pass-through core includes: requesting, by the one interrupt pass-through core, the remote timer capable of using a generic timer in a hardware architecture from the non-interrupt pass-through core; driving the remote timer using the generic timer by the one interrupt pass-through core.

Alternatively, the interrupt pass-through core may request a timer by calling a relevant function.

Alternatively, the generic timer in the hardware architecture may be an ARM ARCH generic timer.

At operation S502, the one interrupt pass-through core executes a service corresponding to a timeout of the software timer, in response to the one interrupt pass-through core receiving an SGI indicating the timeout of the remote timer via the FIQ. Here, the interrupt pass-through core and the non-interrupt pass-through core may perform the above inter-core communication method, which are not described in detail herein.

As such, by means of the remote timer of the non-interrupt pass-through core, the interrupt pass-through core may receive the interrupt of the remote timer via the FIQ, to execute the relevant function of the timer requested by the user, thereby ensuring a good user experience.

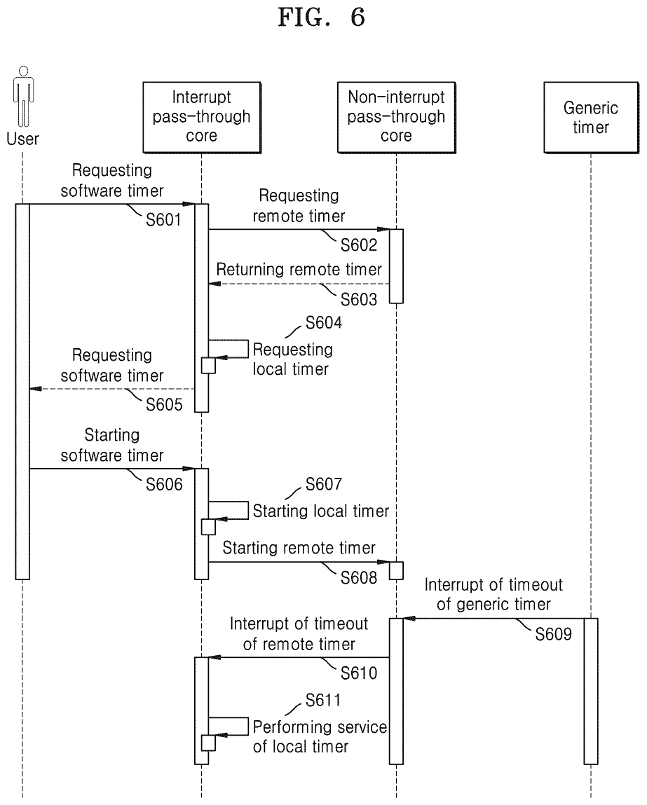

In addition, a local timer may be used in order to ensure that the corresponding operation, processing or function is accurately performed when a timeout indication is received from the remote timer. Alternatively, the driving the remote timer of the one non-interrupt pass-through core by the one interrupt pass-through core includes: requesting a local timer on the one interrupt pass-through core; starting the local timer at the same time as starting the remote timer, and wherein executing the service corresponding to the timeout of the software timer by the one interrupt pass-through core, in response to the one interrupt pass-through core receiving the SGI indicating the timeout of the remote timer via the FIQ, includes: determining a timeout of the local timer, in response to receiving the SGI indicating the timeout of the remote timer via the FIQ; executing the service corresponding to the timeout of the local timer. This is described in detail below in connection with FIG. 6.

FIG. 6 illustrates a flowchart of a method of driving a timer according to some example embodiments of the present disclosure.

Referring to FIG. 6, at operation S601, a user requests a software timer on an interrupt pass-through core.

At operation S602, the interrupt pass-through core request a remote timer to the non-interrupt pass-through core since a generic timer in a hardware architecture cannot be used.

At operation S603, the non-interrupt pass-through core returns the remote timer to the interrupt pass-through core in response to the request for the remote timer. The interrupt pass-through core may determine information related to the returned remote timer based on this remote timer, for a subsequent processing related to a timeout of the remote timer. At operation S604, the interrupt pass-through core requests a local timer.

At operation S605, the interrupt pass-through core returns the local timer to the user. The user may use the returned local timer as the requested software timer for the related processing, e.g., the user may start or stop the timer, may define a service related to a timeout of the timer, etc.

At operation S606, the user starts the software timer. That is, the user instructs the interrupt pass-through core to start the local timer.

At operation S607, the interrupt pass-through core starts the local timer, and at the same time, at operation S608, the interrupt pass-through core starts the remote timer of the non-interrupt pass-through core. That is, the remote timer starts timing using the generic timer while starting the local timer.

At operation S609, the non-interrupt pass-through core receives an interrupt indicating that the generic timer times out. Here, the non-interrupt pass-through core may receive the interrupt in various manners, which are not described in detail.

At operation S610, the non-interrupt pass-through core transmits an interrupt indicating that the remote timer times out, to the interrupt pass-through core. Specifically, the non-interrupt pass-through core transmits a SGI of a timeout of the remote timer to the interrupt pass-through core via a FIQ, to notify a timeout of the local timer. Here, the method of transferring the SGI via the FIQ is the same as the operations described with reference to FIGS. 2 to 4 and is not described in detail here.

At operation S611, the interrupt pass-through core determines that the local timer times out in response to receiving the interrupt indicating the timeout of the remote timer, and performs a service corresponding to the timeout of the local timer.

Here, although one local timer and one remote timer are illustrated in FIG. 6, the example embodiment of the present disclosure is not limited thereto, and they may be one or more.

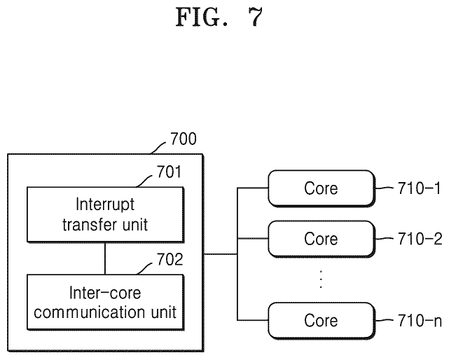

FIG. 7 illustrates a structural block diagram of an inter-core communication apparatus according to some example embodiments of the present disclosure.

Referring to FIG. 7, the inter-core communication apparatus 700 includes an interrupt transfer unit 701 and an inter-core communication unit 702.

In FIG. 7, a plurality of cores 710-1 to 710-n (wherein n is an integer greater than 1) and the inter-core communication apparatus 700 for communication between the plurality of cores 710-1 to 710-n are shown. Although not shown in FIG. 7, as mentioned above, the plurality of cores 710-1 to 710-n may include at least one interrupt pass-through core and at least one non-interrupt pass-through core.

The interrupt transfer unit 701 is configured to: with respect to at least one interrupt pass-through core configured for an interrupt pass-through mode among a plurality of cores 710-1 to 710-n, transmit a physical interrupt directly to a client without going through a virtual machine manager (Hypervisor) in response to the physical interrupt. The inter-core communication unit 702 is configured to perform communication between the plurality of cores 710-1 to 710-n using an operation request such as a Fast Interrupt Request (FIQ).

That is, the interrupt transfer unit 701 and the inter-core communication unit 702 may perform the above operations S201 and S202, respectively, the details of the operations involved in the inter-core communication method mentioned above will not be described in detail in the following description, but may be seen as the descriptions in FIGS. 2 to 6.

Alternatively, the client is running at an exception level 1, and the Hypervisor and the plurality of cores 710-1 to 710-n are running at an exception level 2.

Alternatively, the inter-core communication unit 702 is configured to perform the communication between the plurality of cores 710-1 to 710-n using the Fast Interrupt Request (FIQ) by: transferring a Software Generated Interrupt (SGI) between the plurality of cores 710-1 to 710-n through the FIQ.

Alternatively, the inter-core communication unit 702 is configured to transfer the SGI between the plurality of cores 710-1 to 710-n through the FIQ by: controlling a source core which is a communication transmitting side among the plurality of cores 710-1 to 710-n, to set an interrupt number SGI ID indicating the SGI into a global variable; triggering, by writing to a SGI register by the source core, a Generic Interrupt Controller (GIC) to generate the FIQ to be transmitted to a target core which is a communication receiving side among the plurality of cores 710-1 to 710-n; controlling the GIC to transmit the FIQ to the target core, to instruct the target core to acquire the SGI ID from the global variable.

Alternatively, the inter-core communication unit 702 is configured to transfer the SGI between the plurality of cores 710-1 to 710-n through the FIQ by: controlling a target core which is a communication receiving side among the plurality of cores 710-1 to 710-n to receive the FIQ, wherein the target core is one of the at least one interrupt pass-through core; controlling the target core to acquire an SGI ID indicating the SGI from a global variable in response to the FIQ being received by the target core, wherein the SGI ID is set into the global variable by a source core which is a communication transmitting side; controlling the target core to perform a corresponding processing based on the SGI indicated by the SGI ID.

Alternatively, the inter-core communication apparatus 700 further includes a timer service unit (not shown). The timer service unit is configured to: when a software timer of the Hypervisor is driven on one interrupt pass-through core of the at least one interrupt pass-through core, control the one interrupt pass-through core to drive a remote timer of one non-interrupt pass-through core that is not configured for the interrupt pass-through mode among the plurality of cores; control the one interrupt pass-through core to execute a service corresponding to a timeout of the software timer, in response to the one interrupt pass-through core receiving an SGI indicating the timeout of the remote timer via the FIQ.

Alternatively, the timer service unit is configured to control the one interrupt pass-through core to drive the remote timer of the one non-interrupt pass-through core by: controlling the one interrupt pass-through core to request the remote timer capable of using a generic timer in a hardware architecture from the non-interrupt pass-through core; controlling the one interrupt pass-through core to drive the remote timer using the generic timer.

Alternatively, the timer service unit is configured to control the one interrupt pass-through core to drive the remote timer of the one non-interrupt pass-through core by: requesting a local timer on the one interrupt pass-through core; starting the local timer at the same time as starting the remote timer, and wherein, the controlling the one interrupt pass-through core to execute the service corresponding to the timeout of the software timer, in response to the one interrupt pass-through core receiving the SGI indicating the timeout of the remote timer via the FIQ includes: determining a timeout of the local timer, in response to receiving the SGI indicating the timeout of the remote timer via the FIQ; executing the service corresponding to the timeout of the local timer.

Alternatively, the at least one interrupt pass-through core in the interrupt pass-through mode is implemented, by configuring a register of the at least one interrupt pass-through core by the Hypervisor.

With respect to the inter-core communication device 700 in the above example embodiment, the specific manner in which the respective unit performs operations thereof has been described in detail in the example embodiments of the related method, and will not be described in detail here.

Further, it should be understood that the respective unit in the inter-core communication device 700 according to some example embodiments of the present disclosure may be implemented as hardware components and/or software components. A person of skill in the art may, for example, use a field-programmable gate array (FPGA) or an application-specific integrated circuit (ASIC) to implement the individual units, depending on the processing performed by the individual units as defined.

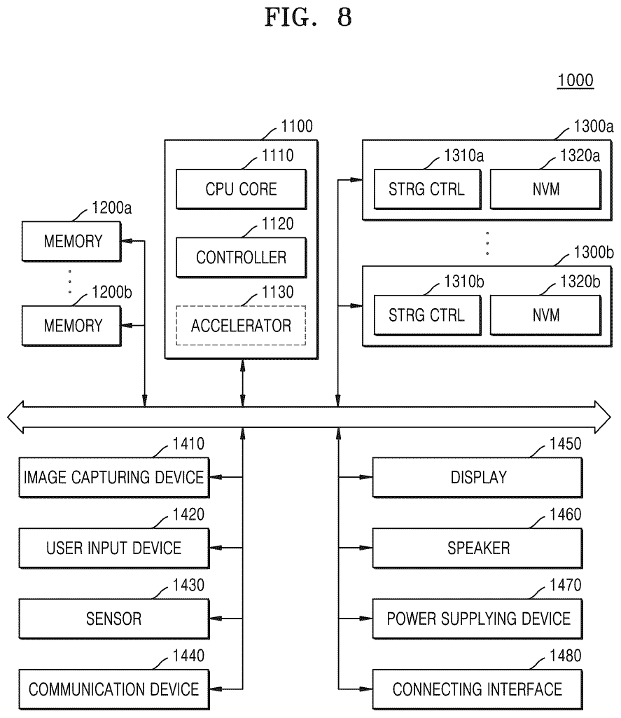

According to some example embodiments of the present disclosure, a system including a processor may also be provided, wherein the processor may be configured to perform the inter-core communication methods as described above. This is described below with reference to FIG. 8.

FIG. 8 is a diagram of a system according to some example embodiments of the present disclosure. The system 1000 of FIG. 8 may basically be a mobile system, such as a portable communication terminal (e.g., a mobile phone), a smartphone, a tablet personal computer (PC), a wearable device, a healthcare device, or an Internet of things (IOT) device. However, the system 1000 of FIG. 8 is not necessarily limited to the mobile system and may be a PC, a laptop computer, a server, a media player, or an automotive device (e.g., a navigation device).

Referring to FIG. 8, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor. The main processor 1100 may be configured to perform the inter-core communication methods according to some example embodiments of the present disclosure. The main processor 1100 may be configured to perform the inter core communication methods according to some exemplary embodiments of the present disclosure.

The main processor 1100 may include at least one CPU core (for example, the plurality of cores as mentioned above) 1110 and further include a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator (for example, the Hypervisor which is the virtual machine manage as mentioned above) 1130 may include a graphics processing unit (GPU), a neural processing unit (NPU) and/or a data processing unit (DPU) and be implemented as a chip that is physically separate from the other components of the main processor 1100. In addition, the main processor 1100 may also include an interrupt transfer unit (not shown), an inter-core communication unit (not shown), and a timer service unit (not shown), they may be used to perform the corresponding operations in the inter-core communication methods as described above. In addition, the main processor 1100 may also include a Hypervisor (not shown) which is a virtual machine manager, however, the present application is not limited to this. The interrupt transfer unit, the inter-core communication unit, the timer service unit, and the virtual machine manager may also be implemented as a processor or processing circuit independent of the main processor 1100 in overall or separately.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory) s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 100 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The communication device 1440 may transmit and receive signals between other devices outside the system 1000 according to various communication protocols. The communication device 1440 may include an antenna, a transceiver, and/or a modem.

The power supplying device 1470 may appropriately convert power supplied from a battery (not shown) embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

According to some example embodiments of the present disclosure, a computer device is also provided. The computer equipment includes: at least one processor, and at least one memory storing computer executable instructions. The computer executable instructions, when being executed by the at least one processor, cause the at least one processor to perform the inter-core communication method as described in the above example embodiment.

As an example, the computer equipment may be a PC computer, a tablet device, a personal digital assistant, a smartphone, or other devices capable of executing the above set of instructions. Here, the computer equipment does not have to be a single electronic device, but may also be an assembly of any device or circuit that is capable to execute the above instructions (or instruction sets) individually or jointly. The computer equipment may also be a part of an integrated control system or system manager, or may be configured as a portable computer equipment that is interfaced with a local or remote (e.g., via wireless transmission).

In the computer equipment, the processor may include a central processing unit (CPU), a graphics processing unit (GPU), a programmable logic device, a specialized processor system, a microcontroller, or a microprocessor. By way of example and not limitation, processors may also include an analog processor, a digital processor, a microprocessor, a multicore processor, a processor array, a network processor, and the like.

The processor may execute the instructions or codes stored in the memory, wherein the memory may also store data.

According to some example embodiments of the present disclosure, a computer-readable storage medium is also provided. Instructions in the computer-readable storage medium, when being executed by at least one processor, cause the at least one processor to perform the inter-core communication method as described in the above example embodiment.

Examples of computer-readable storage medium here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state hard disk (SSD), card memory (such as a multimedia card, secure digital (SD) card, or extreme digital (XD) card), magnetic tape, floppy disk, magneto-optical data storage device, optical data storage device, hard disk, solid state disk, and any other devices configured to store the computer applications and any associated data, data files and data structures in a non-transitory manner, and provide the computer applications and any associated data, data files and data structures to a processor or computer so that the processor or computer can execute the computer applications. The computer applications in the above-mentioned computer readable-storage medium can be executed in an environment deployed in a computer device such as a client, a host, a proxy device, a server, etc. in addition, in one example, the computer applications and any associated data, data files and data structures are distributed over networked computer systems so that the computer applications and any associated data, data files and data structures are stored, accessed and executed in a distributed manner by one or more processors or computers.

According to some example embodiments of the disclosure, computer software may be further provided, and instructions in the computer software may be executed by at least one processor to implement the inter-core communication method as described in the above example embodiments.

After considering the description and practicing the present invention disclosed herein, those skilled in the art are easily think of other example embodiments of the present disclosure. The present application intends to cover any variation, use or adaptation of the present disclosure, which follow general principles of the present disclosure and include the common general knowledge or frequently used technical means in the technical field, which are not disclosed in the present disclosure. The description and the example embodiments are only regarded as examples, and the true scope and spirit of the present disclosure are indicated by the claims.

Any of the elements and/or functional blocks disclosed above may include or be implemented in processing circuitry such as hardware including logic circuits; a hardware/software combination such as a processor executing software; or a combination thereof. For example, the vCPU, Hypervisor, vGIC, GIC, interrupt transfer unit 701, inter-core communication unit 702 and the plurality of cores may be implemented as processing circuitry. The processing circuitry specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Processor(s), controller(s), and/or processing circuitry may be configured to perform actions or operations by being specifically programmed to perform those action or operations (such as with an FPGA or ASIC) or may be configured to perform actions or operations by executing instructions received from a memory, or a combination thereof.

It should be understood that the present disclosure is not limited to the precise structure described above and shown in the drawings, and various modifications and changes may be made without departing from its scope. The scope of the present disclosure is limited only by the claims.

1. An inter-core communication method comprising:
transmitting, with respect to at least one interrupt pass-through core configured for an interrupt pass-through mode among a plurality of cores a physical interrupt directly to a client without going through a Hypervisor in response to the physical interrupt occurring, the Hypervisor being a virtual machine manager; and
performing communication between the plurality of cores using a Fast Interrupt Request (FIQ).

2. The method of inter-core communication according to claim 1, wherein the client is running at an exception level 1, and the Hypervisor and the plurality of cores are running at an exception level 2.

3. The method of inter-core communication according to claim 1, wherein the performing the communication between the plurality of cores using the FIQ comprises:
transferring a Software Generated Interrupt (SGI) between the plurality of cores through the FIQ.

4. The method of inter-core communication according to claim 3, wherein the transferring the SGI between the plurality of cores through the FIQ comprises:
setting an interrupt number SGI ID indicating the SGI into a global variable by a source core which is a communication transmitting side among the plurality of cores;
triggering, by writing to a SGI register by the source core, a Generic Interrupt Controller (GIC) to generate the FIQ to be transmitted to a target core which is a communication receiving side among the plurality of cores; and
transmitting the FIQ to the target core by the GIC, to instruct the target core to acquire the SGI ID from the global variable.

5. The method of inter-core communication according to claim 3, wherein the transferring the SGI between the plurality of cores through the FIQ comprises:
receiving the FIQ by a target core, the target core being a communication receiving side among the plurality of cores, wherein the target core is one of the at least one interrupt pass-through core;
acquiring an SGI ID indicating the SGI from a global variable by the target core in response to the FIQ being received by the target core, wherein the SGI ID is set into the global variable by a source core which is a communication transmitting side; and
performing a corresponding processing by the target core based on the SGI indicated by the SGI ID.

6. The method of inter-core communication according to claim 1, further comprising:
in response to a software timer of the Hypervisor being driven on one interrupt pass-through core of the at least one interrupt pass-through core, driving, by one interrupt pass-through core, a remote timer of one non-interrupt pass-through core, the one non-interrupt pass-through core being among the plurality of cores and not configured for the interrupt pass-through mode; and
executing a service corresponding to a timeout of the software timer by the one interrupt pass-through core, in response to the one interrupt pass-through core receiving an SGI indicating the timeout of the remote timer via the FIQ.

7. The method of inter-core communication according to claim 6, wherein the driving the remote timer of the one non-interrupt pass-through core comprises:
requesting, by the one interrupt pass-through core, to the one non-interrupt pass-through core for the remote timer capable of using a generic timer in a hardware architecture; and
driving, by the one interrupt pass-through core, the remote timer using the generic timer.

8. The method of inter-core communication according to claim 7, wherein
the driving the remote timer of the one non-interrupt pass-through comprises
requesting a local timer, on the one interrupt pass-through core, and
starting the local timer at the same time as starting the remote timer, and
wherein the executing the service corresponding to the timeout of the software timer by the one interrupt pass-through core, in response to the one interrupt pass-through core receiving the SGI indicating the timeout of the remote timer via the FIQ, comprises
determining a timeout of the local timer, in response to receiving the SGI indicating the timeout of the remote timer via the FIQ, and
executing the service corresponding to the timeout of the local timer.

9. The method of inter-core communication according to claim 1, wherein the at least one interrupt pass-through core in the interrupt pass-through mode is implemented, by configuring a register of the at least one interrupt pass-through core by the Hypervisor.

10. An inter-core communication apparatus comprising:
an interrupt transfer unit configured to, with respect to at least one interrupt pass-through core among a plurality of cores and configured for an interrupt pass-through mode, transmit a physical interrupt directly to a client without going through a Hypervisor in response to the physical interrupt occurring, the Hypervisor being a virtual machine manager; and
an inter-core communication unit configured to perform communication between the plurality of cores using a Fast Interrupt Request (FIQ).

11. The inter-core communication apparatus according to claim 10, wherein the client is running at an exception level 1, and the Hypervisor and the plurality of cores are running at an exception level 2.

12. The inter-core communication apparatus according to claim 10, wherein the inter-core communication unit is configured to perform the communication between the plurality of cores using the Fast Interrupt Request (FIQ) by:
transferring a Software Generated Interrupt (SGI) between the plurality of cores through the FIQ.

13. The inter-core communication apparatus according to claim 12, wherein the inter-core communication unit is configured to transfer the SGI between the plurality of cores through the FIQ by:
controlling a source core which is a communication transmitting side among the plurality of cores, to set an interrupt number SGI ID indicating the SGI into a global variable;
triggering, by writing to a SGI register by the source core, a Generic Interrupt Controller (GIC) to generate the FIQ to be transmitted to a target core which is a communication receiving side among the plurality of cores; and
controlling the GIC to transmit the FIQ to the target core, to instruct the target core to acquire the SGI ID from the global variable.

14. The inter-core communication apparatus according to claim 12, wherein the inter-core communication unit is configured to transfer the SGI between the plurality of cores through the FIQ by:
controlling a target core, the target core being a communication receiving side among the plurality of cores to receive the FIQ, wherein the target core is one of the at least one interrupt pass-through core;
controlling the target core to acquire an SGI ID indicating the SGI from a global variable in response to the FIQ being received by the target core, wherein the SGI ID is set into the global variable by a source core which is a communication transmitting side; and
controlling the target core to perform a corresponding processing based on the SGI indicated by the SGI ID.

15. The inter-core communication apparatus according to claim 10, further comprising a timer service unit configured to:
in response to a software timer of the Hypervisor being driven on one interrupt pass-through core of the at least one interrupt pass-through core, control the one interrupt pass-through core to drive a remote timer of one non-interrupt pass-through core among the plurality of cores and not configured for the interrupt pass-through mode;
control the one interrupt pass-through core to execute a service corresponding to a timeout of the software timer, in response to the one interrupt pass-through core receiving an SGI indicating the timeout of the remote timer via the FIQ.

16. The inter-core communication apparatus according to claim 15, wherein the timer service unit is configured to control the one interrupt pass-through core to drive the remote timer of the one non-interrupt pass-through core by:
controlling the one interrupt pass-through core to request the remote timer capable of using a generic timer in a hardware architecture from the one non-interrupt pass-through core;
controlling the one interrupt pass-through core to drive the remote timer using the generic timer.

17. The inter-core communication apparatus according to claim 16, wherein the timer service unit is configured to control the at least one interrupt pass-through by
requesting a local timer, on the one interrupt pass-through core, and
starting the local timer at the same time as starting the remote timer, and
wherein, the controlling the one interrupt pass-through core to execute the service corresponding to the timeout of the software timer, in response to the one interrupt pass-through core receiving the SGI indicating the timeout of the remote timer via the FIQ comprises
determining a timeout of the local timer, in response to receiving the SGI indicating the timeout of the remote timer via the FIQ, and
executing the service corresponding to the timeout of the local timer.

18. The inter-core communication apparatus according to claim 10, wherein the at least one interrupt pass-through core in the interrupt pass-through mode is implemented, by configuring a register of the at least one interrupt pass-through core by the Hypervisor.

19. (canceled)

20. A computer-readable storage medium, wherein, instructions in the computer-readable storage medium, when being executed by at least one processor, cause the at least one processor to perform the inter-core communication method according to claim 1.
